(19) United States
(12) Patent Application Publication
(10) Pub. No.: US 2007/0089365 A1
(43) Pub. Date: Apr. 26, 2007

(54) Plant watering system

(76) Inventor: Rick Rowe, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/257,947

(22) Filed: Oct. 24, 2005

(51) Int. Cl. A01G 27/00

(52) U.S. Cl. 47/79

(57) ABSTRACT

A plant watering system particularly suited for use in watering indoor, potted plants, includes a plurality of plant watering devices and a main controller. Each plant watering device including a fluid reservoir, a fluid outlet from which fluid may be dispensed to an adjacent plant, and an electronically controlled flow controller controlling the flow of fluid from the reservoir to the outlet. The main controller includes a user input and a control unit configured to generate watering device control signals. Control signals are transmitted from the main controller to each watering device wirelessly.

### FIELD OF THE INVENTION

The present invention relates to a method and system for watering plants.

### BACKGROUND OF THE INVENTION

Gardening is a very popular past time. In urban environments and indoors, gardening is often limited to growing potted plants. Unfortunately, there are several drawbacks or problems associated with growing and tending potted plants.

The most significant problem in tending to potted plants is watering and feeding them. Generally, the gardener must individually tend to each potted plant, determining when and how much water and food to provide to each plant. Plants of different types may require different amounts of water or water at different intervals. Whether of the same or a different type, plants located in sunny versus shaded areas or located in different types or sizes of pots may all have different levels of water usage. Thus, a gardener may need to tend various plants on an every day basis, watering and/or feeding different plants on different days. Even this difficult tending process requires the presence of the gardener. Thus, when a homeowner leaves their home for a period of time, such as for a vacation, the homeowner must find another party to tend to the plants or else they may die.

Various solutions have been proposed to these problems. In the case of outdoor plants, automated irrigation systems are known. These systems generally utilize pipes to deliver water from a source to a sprinkler head or the like, from which the water is dispensed. A timer is configured to turn valves on an off, thus controlling the flow of water through the pipes.

This type of system, however, is not well suited to use in supplying water to indoor plants. First, the normal irrigation system is configured to deliver water to a number of points using a common delivery pipe. For example, multiple sprinkler heads for watering a large area are supplied water using a single delivery pipe. This configuration does not work with indoor plants, where each plant needs to be provided a unique amount of water at unique watering schedules.

In addition, these irrigation systems are dependent upon a network of connected pipes to deliver water. In the outdoor environment, these pipes can be run underground so as to not be visible and to avoid their being an obstacle. Again, this configuration is not well-suited to the indoor/house environment. Pipes can not be conveniently run about a house. Aside from the fact the pipes can't be readily be buried and are thus unsightly and interfere with use of the home, house plants may be moved about and may be located in various positions, including by hanging them.

Some solutions particular to potted plants have been proposed. For example, one proposed solution is to provide potted plants with a bowl or tray which can be filled with water. Water is drawn or “wicked” by the soil up from the bowl to the potted plant. Unfortunately, this solution does not address individual plant watering requirements, especially relative to plants which are best-suited to infrequent watering.

### SUMMARY OF THE INVENTION

The invention is a plant watering system and a method of watering one or more plants. The invention has particular utility to watering indoor, potted plants.

In one embodiment, the system includes a main controller and one or more watering devices. Each watering device includes a reservoir capable of containing water to be delivered to one or more plants, a conduit leading from the reservoir to an outlet from which the water is dispensed to the one or more plants, and an electronically controlled flow controller controlling the flow of water from the reservoir through the conduit to the outlet. The main controller includes at least one user input and a controller configured to generate watering device control signals. Preferably, watering device control signals are transmitted wirelessly from the main controller to the watering devices.

In one embodiment, the reservoir is located in a body which is configured as an ornamental element, such as a statue. The watering device controller and other components may also be located in the ornamental element, whereby the watering device is configured as a portable, stand-alone device. In one embodiment, a conduit, such as a tube or pipe, leads from the reservoir to the outlet. The flow controller may comprise a pump which draws fluid from the reservoir, or a valve which controls the flow of fluid from the reservoir.

The system may include one or more moisture sensors. The sensors may be placed in the soil of the plant which is being watered. In one embodiment, a sensor is associated with a particular watering device. Moisture sensor data is provided by the watering device back to the main controller, where it may be used to adjust water delivery or generate a warning.

In one embodiment, the main controller includes a display, such as a touch sensitive display, used to display watering information. The information may include graphical information regarding the watering devices, including their relative locations (such as mapped to a house floor plan). The main controller preferably includes a data storage device for storing user inputted information, generated watering information (such as watering start times and water durations), as well as pre-programmed watering schedules. In one embodiment, a user may input information regarding a plant to be watered, such as pot size, soil type, plant size, and/or plant characteristic, which information is used to generate the watering schedule for a particular plant.

In one embodiment, the main controller is configured to transmit “water on” commands or instructions to each watering device at the appropriate times. The watering devices then control the flow controllers thereof to permit water to flow to the plant(s). When the watering time is over, the main controller sends a signal to the watering device to shut off the flow of water. In another embodiment, program information may be transmitted to a controller of the watering device, and the watering device may generate such signals and locally control the flow controller. In this embodiment, after initial programming, communication with the main controller is not required in order for the watering strategy to be implemented.

In one embodiment, the watering devices may include a flow controller automatic shut-off. The shut-off may be used to ensure water flow at each watering device is shut off in the event the communication link is lost.

Further objects, features, and advantages of the present invention over the prior art will become apparent from the detailed description of the drawings which follows, when considered with the attached figures.

### DESCRIPTION OF THE DRAWINGS

FIG. 1 illustrates a plant watering system in accordance with an embodiment of the invention;

FIG. 2 schematically illustrates one embodiment of a main controller of a plant watering system in accordance with the invention;

FIG. 3 illustrates a watering device and associated plant of a plant watering system of the invention;

FIG. 4 schematically illustrates one embodiment of a watering device of a system of the invention; and

FIG. 5 schematically illustrates a second embodiment of a communication configuration for a system of the invention.

### DETAILED DESCRIPTION OF THE INVENTION

The invention is a method and system for watering one or more plants. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a plant watering system and a method of watering one or more plants. In one embodiment, the system includes a main controller which communicates with individual watering devices. Each watering device includes at least one water reservoir from which water is drawn and delivered to a plant.

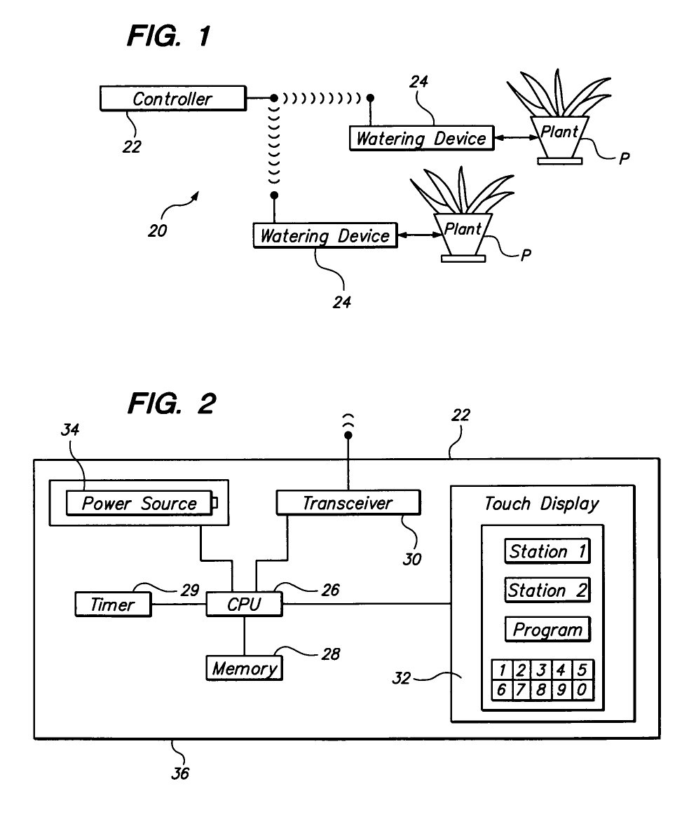

One embodiment of a system 20 of the invention will be described with reference to FIG. 1. As illustrated, the system 20 includes a main or base controller 22 and at least one watering device 24. Each watering device 24 is configured to deliver water to one or more plants P. In a preferred embodiment, the plant or plants P which are watered by a particular watering device 24 are located proximate the watering device 24.

As described below, the main controller 22 is configured to control the one or more watering devices 24. One or more of the watering devices 24 may be located remotely from the main controller 22. In a preferred embodiment, the main controller 22 is configured to communicate with the watering devices 24 via a wireless communication link.

FIG. 2 illustrates one embodiment of the main controller 22. As illustrated, the main controller 22 includes a control unit which, in one embodiment, comprises or includes a CPU 26. The CPU 26 may comprise hardware and/or software, and is preferably configured to generate control instructions or signals. The CPU 26 may be, for example, a processing unit configured to execute machine-readable code.

In one embodiment, the main controller 22 includes at least one data storage device or memory 28. The memory 28 may be integrated with or be separate from the CPU 26 (for example, the memory 28 may communicate with the CPU 26 via a bus). The memory 28 may be of a variety of types, including read-only and writeable. In a preferred embodiment, the memory 28 is a writeable type memory, such as RAM.

The main controller 22 preferably includes a timer 29. The timer 29 may be an internal clock, such as associated with the CPU 26 or, as illustrated, a separate device. The timer 29 preferably provides clock or time information.

The main controller 22 includes means for communicating with the watering devices 24. In a preferred embodiment, as detailed below, the main controller 22 communicates with the watering devices 24 via one or more wireless communication links. The protocol/architecture of the communications links may vary. In one embodiment, the main controller 22 includes a wireless transmitter or transceiver 30. The transmitter or transceiver 30 may implement a Bluetooth or IEEE 802.11(xx) protocol/architecture.

In one embodiment, the main controller 22 includes at least one user input. As illustrated, the user input comprises a touch-sensitive or responsive display 32. The display 32 may be, for example, an LCD or LED touch-sensitive device. As described below, the main controller 22 may be configured so that the display 32 displays information at various locations thereof, which if the player touches the corresponding area of the display 32, causes one or more inputs associated with the information displayed in that area, to be generated. In the embodiment illustrated, for example, the display 32 may display “buttons” such as a keypad numbers and the like.

The user input may comprise different or additional devices. For example, the user input may comprise a keypad, one or more buttons or knobs, or any of the wide variety of devices which are now known or later developed for use in accepting input from a user and which generate at least one input signal in response thereto.

The main controller 22 is powered by a power source 34. In the embodiment illustrated, the power source 34 comprises at least one battery. Other power sources 34 may be utilized, such as external power sources (such as AC or DC current provided from a remote battery or a wall socket through standard public power source). In one embodiment, for example, one or more batteries may be used as a power source backup (such as in the case of a public power source failure) or to store energy from a variable source such as a solar panel.

In one embodiment, the main controller 22 may include a housing 36 for housing or supporting the various components thereof. The housing 36 may be, for example, a plastic box having a face plate which supports the display 32, and defining an interior which houses the other components.

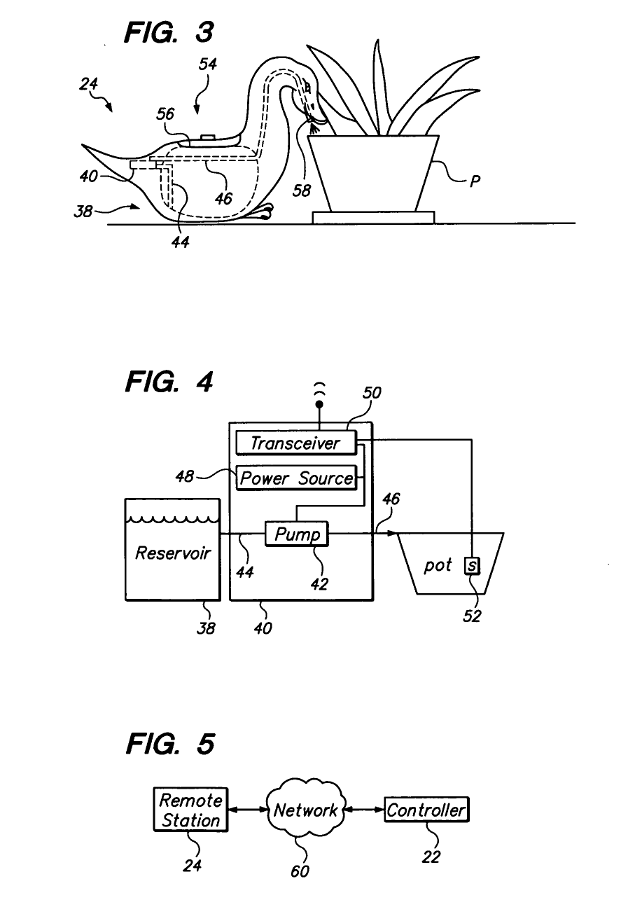

An embodiment of a watering device 24 will be described with reference to FIGS. 3 and 4. Referring first to FIG. 4, in one embodiment, the watering device 24 includes a reservoir 38 and a control unit 40. The reservoir 38 comprises a container configured to contain water (or other fluid, such as a water based solution containing fertilizer). The reservoir 38 is preferably capable of holding a sufficient amount of water to water one or more plants over a period of time (i.e. more than one watering). The reservoir 38 might hold, for example, 2-5 gallons of water.

Preferably, the reservoir 38 is isolated from a water source so as to be stand-alone, and thus must be filled manually. In one embodiment, the reservoir 38 has at least one opening through which water may be delivered into the reservoir, such as by pouring from another container. The reservoir may include a variety of features, such as a one or more filters for filtering contaminants out of the water, a UV light for killing bacteria or the like. The reservoir 38 might include a reservoir/container area for liquid or solid fertilizer. For example, a small separate reservoir may be provided for liquid fertilizer, including a means for dispensing that fertilizer into the water (such as by gravity, timed dispensing and the like).

The control unit 40 of the watering device 24 is configured to cause water to be selectively delivered from the reservoir 38 to a plant P. In one embodiment, the control unit 24 includes means for controlling the flow of water from the reservoir, preferably in the form of an electronically controllable flow controller. In a preferred embodiment, this means comprises a pump 42. In this embodiment, the pump 42 has an inlet or intake which is in communication with the reservoir 38. For example, in one embodiment an intake line 44 leads from the reservoir 38 to the pump 42. The intake line 44 may be, for example, a flexible pipe or other conduit.

The pump 42 has a corresponding outlet to which water is delivered. Water is delivered from the pump 42 to at least one plant. In one embodiment, the pump 42 delivers water to a delivery line 46, the delivery line having an outlet.

The pump 42 may be of a variety of types, such as a reciprocating, rotating impeller type or others. In a preferred embodiment, the pump 42 is electrically powered. In one embodiment, the control unit 40 includes a power source 48. The power source 48 may comprise, for example, a battery or a remote power source (such as public AC power converted to DC by a converter). In one embodiment, the control unit 40 may be solar powered, such as including one or more solar panels and a chargeable battery.

Means are provided for selectively turning the pump 42 on and off. In one embodiment, primary control over the pump 42 is from the main controller 22 (see FIG. 1). In particular, the control unit 40 includes a receiver or transceiver 50. The receiver or transceiver 50 is configured to receive information transmitted from the main controller 22. When the main controller 22 is configured to transmit information wirelessly, the transceiver 50 of the control unit 40 is preferably configured to receive wireless transmissions.

In one embodiment, the pump 42 may have an integral controller. When the transceiver 50 receives pump control information, that information may be provided to the pump 42, which causes the pump 42 to turn on or off. In another embodiment, a controller may be associated with the transceiver 50, or a stand-alone controller may communicate with both the transceiver 50 and the pump 42. In one embodiment, the pump 42 is turned on and off by controlling power to the pump 42.

In another embodiment, the watering device 24 may include a local controller or control unit. Signals from the main controller 22 may be transmitted to the local controller (such as via a standardized protocol), which utilizes or executes the signals (such as by turning the pump 42 on or off, such as via a unique signal or protocol).

In one embodiment, the watering device 24 includes one or more additional devices. For example, in one embodiment, the watering device 24 includes a moisture sensor 52. The moisture sensor 52 may be placed into contact with the soil surrounding a plant which is to be watered with the watering system 20. The sensor 52 is configured to generate and transmit an output signal regarding the moisture content. In one embodiment, the sensor 52 may output a “water” signal when the moisture content of the soil falls to or below a particular level. Alternatively, the sensor 52 may transmit actual soil moisture level information. These signals may be transmitted directly via the transmitter 50 or be processed by a local controller of the watering device 24.

The watering device 24 might also include a reservoir level sensor. This sensor might be associated with the reservoir and provide information regarding a level of water in the reservoir. The sensor might be configured to generate a “low level” signal when the water in the reservoir falls below a certain level.

In a preferred configuration, the watering device 24 is portable, permitting it to be used in a variety of locations. In one embodiment, the watering device 24 may be modular, with the reservoir 38 and control unit 40 being separate elements. This might permit, for example, the reservoir to be located in one location and the control unit 40 in another.

Referring to FIG. 3, in a preferred embodiment, the watering device 24 is a self-contained unit. In one embodiment, the watering device 24 is configured as an ornamental element. In the embodiment illustrated, the watering device 24 has the form or appearance of a goose statute or figurine 54. The figurine 54 is configured as a reservoir, and thus includes a water containing portion. In the embodiment illustrated, a portion of the figurine 54 is hollow and accepts water therein. A lid 56 selectively provides access to the interior of the figurine 54, such as for filling the interior with water.

In a preferred embodiment, the control unit 40 is also associated with the figurine 54. As illustrated, the control unit 40 is located in an interior portion thereof, adjacent the water reservoir thereof. In one embodiment, the inlet line 44 leads from the reservoir portion of the figurine 54 to the pump 42. The outlet line 46 leads from the pump 42 through the figurine 54 to an outlet 58. In the preferred embodiment illustrated, the outlet 58 is located at a “beak” portion of the goose simulated figurine. In this configuration, the outlet line 46 may extend through an interior portion of the figurine 54 to the outlet 58. A portion may actually be defined by the figurine (such as in a wall thereof) rather than by a second member, such as separate pipe.

The figurine 54 is positioned adjacent a plant P, so that water which is delivered through the outlet 58 is delivered to the plant P. In one embodiment, as illustrated, the plant P is located in a pot. The outlet 58 is positioned over a rim of the pot and so that water is delivered to the soil surrounding the plant P.

As described above, in one embodiment, a wireless communication link is defined at one or more times between the main controller 22 and each watering device 24. The communication link(s) may be defined by one or more additional components. For example, relays may be provided between the main controller 22 and watering devices 24 which are located far from the main controller 22. In one embodiment, each watering device 24 may be configured as a relay, re-broadcasting signals which it receives which are not for that particular device 24.

The system 20 of the invention may have a number of configurations. In a preferred embodiment, a watering device 24 is associated with each plant P to be watered. In this manner, each watering device 24 can be positioned adjacent the plant P to be watered, avoiding the need for piping or the like, which piping may be undesirable either from an aesthetic or functional perspective. In another embodiment, however, the watering device 24 could be configured to deliver water to more than one plant. For example, the outlet of the pump 42 may be configured to deliver water to more than one outlet, and each of those outlets may be configured to deliver water to a different plant (whether different outlet lines may be extended directly to different plants or be part of the same or different ornamental elements—for example, an “octopus” figurine may have outlets at each of eight simulated legs, whereby the watering device may be configured to water eight plants).

The one or more outlets may include a flow regulating device, such as a drip head. In such a configuration, the pump for each watering device may be configured to deliver the water at the same rate, but the actual rate of delivery may be varied by a flow regulating device or controller. For example, for high delivery rates, a spray head may be utilized. For lower delivery rates, a drip head may be utilized. Of course, other types of flow controllers or restrictors may be utilized.

In one embodiment, the means for controlling the flow of water from the reservoir to the plant may be other than a pump. For example, the means for controlling the flow may additionally comprise, or solely comprise, a valve. In one embodiment, the reservoir may be configured to be positioned higher than a plant, whereby water would flow under the pull of gravity from the reservoir to the plant. For example, the reservoir portion of a figurine may be located in the figurine high above a base thereof, or the reservoir/figurine might be configured to be mounted to a wall, on stand or be hung. The control unit may include at least one valve for selectively controlling the flow of water through a conduit from the reservoir to the plant. The valve may be electronically operated.

A method of watering a plant, including by using a system 20 such as illustrated in FIGS. 1-4, will now be described. A watering device 24 is associated with each plant which is to be watered using the system 20. As detailed, in a preferred embodiment, a single watering device 24 is associated with a single plant, though in other embodiments, a watering device 24 may be configured to deliver water to more than one plant.

Preferably, the watering device 24 is positioned so that a water outlet thereof is adjacent the plant. Where the outlet is defined at a portion of a figurine, such as illustrated in FIG. 3, the portion of the figurine may need to be positioned adjacent the plant. In another embodiments, such as where the outlet is the end of a line, such as a flexible hose, the hose may be extended to the plant and the outlet thereof positioned adjacent the plant. By “adjacent” the plant, it is meant a location where delivered water will water the plant, such as by being sprayed onto soil in which the plant is planted.

Next, water or other fluid to be delivered is located in the reservoir of each watering device 24. This may comprise delivering water from a hose or pouring water from a pitcher or other container into the reservoir. As indicated, the water may be a solution containing fertilizer or other materials.

The main controller 22 is then configured to communicate with the control unit 40 of each watering device 24, thus controlling the flow of water from the reservoirs thereof to their associated plants. In one embodiment, the main controller 22 may be configured to execute pre-programmed watering functions. In a preferred embodiment, however, the user of the system 20 may program the system so that each watering device, and thus the water delivery to each plant, is custom-controlled.

In one embodiment, the user programs the main controller 22 using the input device, such as the display 32. In one embodiment, a user may select among a plurality of modes, such as “program,” “set time” and the like. Once in a particular mode, a user may make changes or selections. For example, in the “set time” mode, the user may change the base time of the timer 29 to correspond with the actual time.

In one embodiment, the user may control at least the duration of water delivery and the time of water delivery by each watering device 24. As illustrated, each watering device 24 may be designated by a station number or other identifier. A user might select “Station 1” for a first of the watering stations 24. The user might then select “Program” to program that station.

In one embodiment, the user may be permitted to select or input (such as by using the numbered keys) one or more days of the week the watering device 24 is to deliver water, the one or more times of day, and the duration of the water delivery. For example, the user might program the main controller 22 to cause a first watering device 24 to deliver water each day (M-Tu-W-Th-F-Sa-Su), at 8:00 a.m. for 15 minutes. A user might program the main controller 22 to cause a second watering device 24 to deliver water only once per week (M), at 6 p.m., for 5 minutes.

The programmed instructions maybe stored in the memory 28 of the main controller 22 and be utilized by the CPU 26 in generating control signals which are provided to the transceiver 30 and then transmitted to the various watering devices 24. As indicated, in a preferred embodiment, the control instructions are transmitted wirelessly from the main controller 22 to each watering device 24. The signals may be coded, so as to be recognized and implemented by only the appropriately designated watering device (for example, the data may be “addressed” to particular watering devices 24 or stations).

In one embodiment, the control signals may be signals which cause the appropriate watering devices 24 to cause water to be delivered or to stop water delivery. For example, referring to the above-referenced control program for Station 1, the main controller 22 may transmit a signal to the first watering station 24 which causes it to turn on its pump at 8:00 a.m. on a particular day. Fifteen minutes later, the main controller 22 preferably transmits a signal to that same watering device 24 to turn off the pump, thus stopping the flow of water.

As indicated, the watering devices 24 may implement or process the instructions in various fashions. In one embodiment, the wireless signal from the main controller 22 is received by the receiver 50 of the control unit 40 of the watering device 24. That signal is used to turn on or off the pump 42, such as by controlling the flow of power to the pump. When the pump 42 is turned on, it draws fluid from the associated reservoir 28 and delivers it through the outlet to the associated plant P.

As indicated above, in one embodiment, soil moisture information may be provided by the watering devices 24 to the main controller 22. The moisture detector 52 transmits a signal to the control unit 40 of the watering device 24 which is then transmitted by the transceiver 50 to the main controller 22. The main controller 22 may utilize the moisture information in various manners. In one embodiment, the main controller 22 may be programmed to automatically deliver water to a plant in the event the soil moisture level is below a certain level. In another embodiment, the main controller 22 maybe configured to generate an alert in the event the moisture level is below a certain level or above a certain level. Such an alert might be displayed on the display 32 (“warning: watering station 1 detects dry soil”).

Similarly, if the watering device 24 has a low water sensor, a signal may be provided to the main controller 22 which causes the main controller 22 to generate an alert. The alert preferably includes information which identifies the particular reservoir which is empty (or below a certain level). The watering device 24 may be configured to generate other information or receive information from other sensors, such as information from a fertilizer/nutrient level detector (such where liquid fertilizer is located in a container associated with the reservoir), information regarding device errors, pump failure, water flow error (such as where a water flow rate detector is provided and a sensed flow rate is too high or too low).

The main controller 22 may permit the user to control a wide variety of features of the watering devices 24. For example, in one embodiment, the user may be permitted to control a water flow delivery rate (such as by controlling pump speed). The main controller 22 may also include a number of additional features. For example, the main controller 22 may automatically detect new watering devices 24. When a user locates a watering device 24 in vicinity of the controller 22 and turns the control unit 40 thereof on, the main controller 22 may detect the new watering device and assign it a station number.

In one embodiment, the user may be permitted to associate information with the main controller 22, such as for identifying particular watering devices 24. A user might designate a first station, for example, the “living room” watering station due to its location in that room. A user might also designate a station as the “Jade plant” watering device to so identify it.

In one embodiment, the main controller 22 may include pre-programmed control sequences. For example, the main controller 22 may permit a user to identify a particular plant or the characteristic of that plant (i.e. “desert plant” or “cactus”). One or more control strategies may be associated with those identifiers. For example, a user may select “cactus” and the main controller 22 may automatically implement a low water delivery program for that plant.

In other embodiments, the user might provide plant characteristics, such as plant size, pot size, type of soil or the like, which information is used by the main controller 22 to designate and/or implement a particular watering strategy for the plant(s). For example, the main controller 22 may include a database of plant types, plant characteristics or the like, and associated watering data, such as suggested watering schedules for such plants.

In one embodiment, the main controller 22 may be programmed to display a “map” of watering devices. For example, the main controller 22 may permit a user to configure a layout of their home (such as by showing connected boxes or the like representing various rooms and their corresponding positions). Particular watering devices 24 may be associated with the rooms, permitting the user to easily identify them.

The watering devices 24 may be configured to provide additional information to the main controller 22. For example, the watering devices 24 may be configured to transmit a “low battery” signal to the main controller 22 which causes the main controller 22 to generate a user alert. The watering devices 24 may also be configured with other sensors or monitors, such as a pump monitor. If the pump 42 of a particular watering device 24 does not operate, then the watering device 24 may be configured to send an appropriate signal to the main controller 22.

In one embodiment, the watering devices 24 may be configured with an automatic pump shutoff. The pump shutoff may automatically shut off the pump after a period of time, such as 30 minutes, to avoid over-watering in the event communications are lost and the watering device 24 does not receive a pump-off signal from the main controller 22.

In one alternate embodiment of the invention, the control unit 40 of each watering device 24 may be programmable. In that configuration, each control unit 40 may include a data storage device or memory and a controller configured to utilize associated data for executing various control instructions. In this embodiment, program instructions may be transmitted from the main controller 22 to the control unit 40 of each watering device 20. The control unit 40 of each watering device 20 may then control the pump or other water control device(s) associated therewith.

For example, in such an embodiment, the user may program a watering device 24 from the main controller 22. The main controller 22 may then send program information to the watering device 24, which stores that information. The control unit 40 of the watering device uses the program data to execute watering events independent of specific control signals being transmitted from the main controller 22 to the watering device 24 in the manner described above. In this embodiment, a particular watering device 24 will maintain a particular watering program until the main controller 22 send new program information. Further, in this embodiment the control unit 40 may receive and process data from the moisture sensor 50, such as to directly provide additional water in the case of a low moisture level.

In a preferred embodiment, the communication link between each and every watering device 24 and the main controller 22 is wireless. In another embodiment, however, one or more wired communication links could be utilized. For example, a wired link may be provided between the main controller 22 and watering devices 24 which are located very close to the main controller 22, such as those watering devices 24 located in the same room.

Referring to FIG. 5, the communication links between the main controller 22 and the watering devices 24 may be part of a larger communication network 60. This network 60 may have a variety of configurations and may comprise a number of wired, wireless or a combination of wired and wireless communication pathways. Depending upon the configuration of the network 60, the network 60 may comprise a wide variety of components. The network 60 may include one or more hubs or routers. The network 60 may include dedicated or public lines. For example, one or more portions of the network 60 may include the Internet, phone lines or the like.

In one embodiment, for example, the network 60 may include a desktop computer, the Internet, the main controller 22 and the watering devices 24. A user of the system 20 may communicate with the main controller 22 via their desktop computer which is connected to the Internet (where the main controller 22 is also connected to the Internet or to another device that is). In this manner, a user may be able to check the status of the system 20 from a remote location (such as while on vacation in order to ensure that all of the watering devices 24 are working properly, to check for “low moisture” alerts and the like).

In one embodiment, the main controller 22 may actually comprise a computing device, such as a desk top or lap-top computer. The computer may implement one or more programs which may generate user interfaces for display, and which may generate watering or control information. The computer is preferably configured to include a wireless communication transmitter and/or receiver.

The system and method of the invention has numerous advantages. First, the system does not require plumbing lines or electrical or wired or cabled communication lines. Instead, each watering device includes its own water supply and wireless communications avoid the need for communication lines. In this manner, the system is not intrusive to a home or similar environment and does not interfere with the use of the home.

Second, the system permits watering of as few as one plant, or many plants, simply by changing the number of watering devices associated with the controller. Watering devices may be easily added or moved, since no plumbing, electrical or communication lines are needed. Instead, a new watering device can simply be located near a plant and then be programmed into the main controller to receive control instructions.

In one embodiment, the watering device is completely self-contained, including the water reservoir and flow controller. In an ornamental configuration, the watering device becomes “transparent” as such a device to viewers thereof. Instead, the watering devices can appear as “art” rather than as functional items. Again, this is important in the setting of a home. The watering devices can also have various forms. They can, for example, be configured to be hung from a ceiling or sit upon the floor.

The system may include various additional features which provide additional advantages over current watering techniques. For example, the system may include moisture sensors, enabling the system or user to adjust watering based on actual sensed conditions. In one embodiment, a user may be permitted to access system information from a remote location and even change watering program information remotely.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A plant watering system comprising:
a plurality of plant watering devices, each plant watering device including a reservoir capable of containing fluid to be delivered to one or more plants, a conduit leading from said reservoir to an outlet from which said fluid is dispensed to said one or more plants, an electronically controlled flow controller controlling the flow of fluid from said reservoir through said conduit to said outlet, and a receiver configured to receive wireless control instructions and provide electronic signals to said flow controller; and
a main controller including at least one user input, a data storage device configured to store watering device control data, a control unit configured to generate watering device control signals based upon said control data, and a transmitter configured to transmit control signals over one or more wireless communication links to said plant watering devices.

2. The plant watering system in accordance with claim 1 wherein said reservoir is located within an ornamental item.

3. The plant watering system in accordance with claim 2 wherein said ornamental item has an opening through which fluid may be delivered to said reservoir, and wherein said flow controller and receiver are located within said ornamental item.

4. The plant watering system in accordance with claim 1 wherein said at least one user input of said main controller comprises a keypad.

5. The plant watering system in accordance with claim 4 wherein said keypad is defined by a touch-sensitive display.

6. The plant watering system in accordance with claim 1 wherein said watering devices include at least one moisture sensor.

7. The plant watering system in accordance with claim 6 wherein said moisture sensors output moisture sensor signals which are transmitted to said main controller.

8. The plant watering system in accordance with claim 1 wherein each watering device includes a local controller, said receiver of each watering device providing said control instructions to said local controller.

9. The plant watering system in accordance with claim 1 wherein said flow controller comprises a pump.

10. A method of watering plants comprising the steps of:
locating a watering device adjacent a plant to be watered, said watering device comprising a body defining an internal reservoir for containing fluid to be delivered to said adjacent plant, a conduit leading from said reservoir to an outlet from which water is dispensed to said adjacent plant, a flow controller controlling the flow of fluid from said reservoir to said outlet;
accepting user input at a main controller;
generating plant watering program data in response to said input;
transmitting plant watering control instructions from said main controller to each watering device over at least one wireless communication link;
receiving said control instructions at said watering device; and
selectively controlling said flow controller to deliver fluid from said reservoir to said adjacent plant.

11. The method in accordance with claim 10 wherein said user input identifies the type of plant to be watered.

12. The method in accordance with claim 10 wherein said user input identifies a characteristic of the plant to be watered.

13. The method in accordance with claim 12 wherein said characteristic is selected from the group consisting of: soil type, water demand, pot size and plant size.

14. The method in accordance with claim 10 wherein said flow controller comprises a pump and said step of selectively controlling said flow controller comprises turning said pump on and off.

15. The method in accordance with claim 10 including a moisture sensor associated with said adjacent plant and including the step of transmitting moisture information from said sensor to said main controller.

16. The method in accordance with claim 15 including the step of generating an alert if the moisture level falls below a particular level.

17. The method in accordance with claim 10 wherein said main controller includes a display and including the step of displaying watering device status information using said display.

18. The method in accordance with claim 10 wherein said step of generating plant watering program data comprises generating watering time data.

19. The method in accordance with claim 10 including providing more than one watering device and positioning each watering device adjacent different plants to be watered, and including the step of addressing said plant watering control instructions to particular of said watering devices.

20. The method in accordance with claim 10 including the step of transmitting information from said watering device to said main controller selected from the group consisting of: low battery, low water level, high moisture level, low moisture level, low nutrient level, pump error, device error and water flow error.

21. The method in accordance with claim 20 including the step of receiving said information from said watering device at said main controller.

22. The method in accordance with claim 21 including the step of generating an alert at said main controller in response to the step of receiving said information.

23. The method in accordance with claim 22 wherein said alert includes an audible alarm.
